(19) United States
(12) Patent Application Publication
(10) Pub. No.: US 2025/0333658 A1
(43) Pub. Date: Oct. 30, 2025

(54) METHOD OF CONVERTING FISCHER-TROPSCH PRODUCTS INTO AROMATICS

(71) Applicant: UOP LLC, Des Plaines, IL (US)

(72) Inventors: Jan De Ren, Arlington Heights, IL (US); Sujoy Ganguly, Buffalo Grove, IL (US); Xi Zhao, Arlington Heights, IL (US)

(21) Appl. No.: 19/262,743

(22) Filed: Jul. 8, 2025

Related U.S. Application Data
(60) Provisional application No. 63/363,785, filed on Apr. 28, 2022.

(51) Int. Cl. C10G 35/085

(52) U.S. Cl. CPC C10G 35/085; C10G 2300/1022; C10G 2300/1044; C10G 2300/4006; C10G 2300/4012; C10G 2300/70; C10G 2400/02; C10G 2400/08

(57) ABSTRACT

Processes for converting Fischer-Tropsch products into aromatics are described. The processes involve processing a selected portion of the Fischer-Tropsch effluent or Fischer-Tropsch plus hydrocracking effluent in a separate, low pressure reforming reaction zone. The feed comprises the portion of the Fischer-Tropsch or Fischer-Tropsch/hydrocracking products boiling around the heavy naphtha and kerosene/light distillate range with a molecular composition of approximately C₆ to C₁₆ paraffins and iso-paraffins which would form alkylated mono or bicyclic compounds boiling in the naphtha-jet range.

### RELATED APPLICATIONS

This application claims priority to U.S. Provisional Patent Application Ser. No. 63/693,785 filed on Sep. 12, 2024, the entirety of which is incorporated herein by reference.

### BACKGROUND

The Fischer-Tropsch process involves converting synthesis gas comprising carbon monoxide and/or carbon dioxide and hydrogen to hydrocarbons using a heterogeneous catalyst.

Fischer-Tropsch synthesis is known to yield a broad mixture of products including primarily paraffins, and some olefins. The individual compounds of such mixture can contain up to about 200 carbons. Typically, the number of carbons is between about 1 and about 150, with an average number of carbons of about 30. Some Fischer-Tropsch processes yield mixtures enriched with C₅-C₃₀ alkanes containing a significant quantity of olefins and oxygenated compounds, such as alcohols or acids. Trace amounts of sulfur-containing or nitrogen-containing products or aromatic compounds can be also present. Such mixtures are known as “light Fischer-Tropsch liquids” or “LFTL.” Both typical Fischer-Tropsch product and LFTL are frequently used as raw materials for obtaining various petrochemical products, such as lubrication oil, kerosene, petroleum distillates, or diesel fuels, among others.

The ASTM D7566 product specifications for aviation turbine fuel containing synthesized hydrocarbons require 8 to 25 vol % aromatics in the overall Jet A and A1 fuel composition, while all types of synthetic paraffinic kerosene (SPK), as blending component made from any permitted path, including Fischer-Tropsch Hydroprocessing, contain a maximum of 0.5 wt % aromatics. Therefore, aromatics need to be added to the SPK to meet the aromatic requirement for Jet A and A1. Additionally, for production of sustainable aviation fuel (SAF) it would be desirable for the aromatics being added came from a non-fossil fuel source.

Therefore, there is a need for an improved process for converting Fischer-Tropsch liquids and waxes derived from non-fossil CO or CO₂ in the syngas into aromatics and/or transportation fuels.

### BRIEF DESCRIPTION OF THE DRAWINGS

FIG. 1 is an illustration of one embodiment of a process for converting Fischer-Tropsch naphtha/distillate into aromatic compounds.

FIG. 2 is an illustration of another embodiment of a process for converting Fischer-Tropsch naphtha/distillate into aromatic compounds.

### DESCRIPTION

The present invention meets this need by providing processes for converting Fischer-Tropsch products into aromatics. The processes involve processing a selected portion of the Fischer-Tropsch effluent or Fischer-Tropsch plus hydrocracking effluent in a separate, low pressure reforming reaction zone. The low-pressure reforming reaction zone typical operates at a a pressure of 60 psig to less than 400 psig, while typical hydroprocessing reaction zones (e.g., hydroteating, hydrocracking, and/or hydroisomeration) operate at pressures of 500 psi to 1500 psi. The reforming reaction zone comprises a reforming reactor loaded with a catalyst which promotes cyclization and aromatics production.

The feed to the reforming reaction zone comprises a portion of the Fischer-Tropsch or Fischer-Tropsch/hydrocracking products boiling around the heavy naphtha (e.g., compounds boiling the range of about 90° C. to about 200° C.) and kerosene/light distillate range (e.g., compounds boiling the range of about 120° C. to about 300° C.) with a molecular composition of approximately C₈ to C₁₆ paraffins and iso-paraffins which would form alkylated mono or bicyclic compounds boiling in the heavy naphtha-jet range (e.g., compound boiling the range of about 90° C. to about 300° C.). The temperature, pressure, and catalyst composition will be selected to produce the needed level of these cyclic compounds while avoiding excessive deactivation.

There are significant economic and environmental incentives to convert Fischer-Tropsch liquids and waxes to other products. Fischer-Tropsch liquids and waxes can be synthesized from biomass, municipal solid waste, biogas, landfill gas, and carbon dioxide combined with hydrogen as a renewable resource. Synthetic paraffinic kerosene (SPK) is blended with aromatics to meet the specifications for Jet A or Jet A1 which require aromatics content. Because SPK contains minimal aromatics and the specifications for Jet A and Jet A1 require aromatics, making the aromatics from Fischer-Tropsch products relieves the blending level limitations of SPK. Aromatics from Fischer-Tropsch products can be blended with other renewable products, such as gasoline, naphtha, chemicals, and the like. This provides an advantage over petroleum-based products with respect to carbon intensity and carbon footprint.

One aspect of the invention is a method of converting Fischer-Tropsch naphtha/distillate to aromatics. One embodiment of the method comprises providing a Fischer-Tropsch naphtha/distillate stream comprising C₆ to C₁₆ normal paraffins. The Fischer-Tropsch naphtha/distillate stream is reformed in a reforming reaction zone comprising a reforming reactor in the presence of a reforming catalyst under reforming conditions to form a reformer effluent stream comprising C₁ to C₅ paraffins, C₆₊ aromatic compounds, and hydrogen. The reformer effluent stream is separated into an overhead gas stream comprising C₁-C₂, an overhead liquid stream comprising C₃-C₅, and an aromatic rich stream comprising the C₆₊ aromatics. The aromatic rich stream is separated in a heavy aromatic splitter column into a light aromatic rich stream comprising C₆₋₇ aromatics and a heavy aromatic rich stream comprising C₈₊ aromatics. The light aromatic rich stream is separated in a light aromatic splitter column into an overhead stream comprising C₆ aromatics and unconverted paraffins and a bottom stream comprising C₇ aromatics and unconverted paraffins. At least a first portion of the overhead stream from the light aromatic splitter column or at least a first portion of the bottom stream from the light aromatic splitter column is recycled to the reforming reaction zone.

In some embodiments, the method further comprises recovering a second portion of the overhead stream from the light aromatic splitter column; or recovering a second portion of the bottom stream from the light aromatic splitter column; or both.

In some embodiments, the method further comprises removing non-aromatics from the second portion of the overhead stream from the light aromatic splitter column, or the second portion of the bottom stream from the light aromatic splitter column, or both.

In some embodiments, the method further comprises blending the bottom stream from the heavy aromatic splitter column with a Fischer-Tropsch synthetic paraffinic kerosene stream according to ASTM D5766 to form a sustainable airplane fuel blend.

In some embodiments, the method further comprises blending the overhead stream from the light aromatic splitter column with a high octane stream to form a gasoline blend. Suitable high octane streams, include but are not limited to, isomerate, alkylate, naphtha, or combinations thereof.

In some embodiments, the method further comprises recovering hydrogen gas from the reforming reaction zone.

In some embodiments, the reforming reaction conditions comprise a temperature in a range of 400° C. to 600° C., or 400° C. to 550° C., or 450° C. to 600° C., 450° C. to 550° C., or a pressure in a range of 60 psig to less than 400 psig, or both. The pressure may be 60 to 390 psig, or 60 to 380 psig, or 60 to 375 psig, or 60 to 350 psig, or 60 to 325 psig, or 60 to 300 psig, or 60 to 275 psig, or 60 to 250 psig, or 60 to 225 psig, or 60 to 200 psig, or, or 60 to 175 psig, or 60-150 psig, or 60-100 psig.

In some embodiments, the reforming catalyst comprises a zeolite based catalyst with greater than 0 up to 1 wt % of a noble metal, or up to 0.75%, or up to 0.5%, or up to 0.3%, or up to 0.2%, or up to 0.1%, or a chlorinated alumina based catalyst with greater than 0 up to 1 wt % of a noble metal, Sn, Ge, Ga, In, Re, or combinations thereof, or up to 0.75%, or up to 0.5%, or up to 0.3%, or up to 0.2%, or up to 0.1%. For example, in some embodiments, the zeolite based catalyst comprises zeolite L with Pt. Noble metals include, but are not limited to, Pt, Ru, Rh, Pd, Os, Ir, and Au.

In some embodiments, providing the Fischer-Tropsch product stream comprises reacting synthesis gas comprising hydrogen, and carbon monoxide and/or carbon dioxide in a Fischer-Tropsch reaction zone comprising a Fischer-Tropsch reactor in the presence of a Fischer-Tropsch catalyst under Fischer-Tropsch reaction conditions to form the Fischer-Tropsch product stream.

In some embodiments, the Fischer-Tropsch reaction conditions comprise a temperature in a range of 150° C. to 300° C., or a pressure in a range of 200 to 750 psig, or both.

In some embodiments, the Fischer-Tropsch catalyst comprises a Fe-, Co-, Ni-, Ru-based catalyst or combinations thereof.

Another aspect of the invention is a method of converting Fischer-Tropsch naphtha/distillate to aromatics. In one embodiment, the method comprises providing a Fischer-Tropsch naphtha/distillate stream comprising C₆ to C₁₆ normal paraffins. The Fischer-Tropsch naphtha/distillate stream is reformed in a reforming reaction zone comprising a reforming reactor in the presence of a reforming catalyst under reforming conditions to form a reformer effluent stream comprising C₁ to C₅, C₆₊ aromatic compounds, and hydrogen. The reformer effluent stream is separated into an overhead gas stream comprising C₁-C₂ paraffins, an overhead liquid stream comprising C₃-C₅ paraffins, and an aromatic rich stream comprising the C₆₊ aromatics. The aromatic rich stream is separated in a heavy aromatic splitter column into a light aromatic rich stream comprising C₆₋₇ aromatics and a heavy aromatic rich stream comprising C₈₊ aromatics. The light aromatic rich stream is separated in a light aromatic splitter column into an overhead stream comprising C₆ aromatics and unconverted paraffins and a bottom stream comprising C₇ aromatics and unconverted paraffins. At least a first portion of the overhead stream from the light aromatic splitter column or at least a first portion of the bottom stream from the light aromatic splitter column is recycled to the reforming reaction zone. A second portion of the overhead stream from the light aromatic splitter column is recovered, and non-aromatics are removed from the second portion of the overhead stream from the light aromatic splitter column; or a second portion of the bottom stream from the light aromatic splitter column is recovered and non-aromatics are removed from the second portion of the bottom stream from the light aromatic splitter column; or both.

In some embodiments, the method further comprises blending the bottom stream from the heavy aromatic splitter column with a Fischer-Tropsch synthetic paraffinic kerosene stream to form a sustainable airplane fuel blend.

In some embodiments, the method further comprises blending the overhead stream from the light aromatic splitter column with a high octane stream to form a gasoline blend.

In some embodiments, the method further comprises recovering hydrogen gas from the reforming reaction zone.

In some embodiments, the reforming reaction conditions comprise a temperature in a range of 400° C. to 600° C., or 400° C. to 550° C., or 450° C. to 600° C., 450° C. to 550° C., or a pressure in a range of 60 psig to less than 400 psig, or both. The pressure may be 60 to 390 psig, or 60 to 380 psig, or 60 to 375 psig, or 60 to 350 psig, or 60 to 325 psig, or 60 to 300 psig, or 60 to 275 psig, or 60 to 250 psig, or 60 to 225 psig, or 60 to 200 psig, or, or 60 to 175 psig, or 60-150 psig, or 60-100 psig.

In some embodiments, the reforming catalyst comprises a zeolite based catalyst with greater than 0 up to 1 wt % of a noble metal, or up to 0.75%, or up to 0.5%, or up to 0.3%, or up to 0.2%, or up to 0.1%, or a chlorinated alumina based catalyst with greater than 0 up to 1 wt % of a noble metal, Sn, Ge, Ga, In, Re, or combinations thereof, or up to 0.75%, or up to 0.5%, or up to 0.3%, or up to 0.2%, or up to 0.1%.

In some embodiments, providing the Fischer-Tropsch product stream comprises: reacting synthesis gas comprising hydrogen, and carbon monoxide, or carbon dioxide, or both in a Fischer-Tropsch reaction zone comprising a Fischer-Tropsch reactor in the presence of a Fischer-Tropsch catalyst under Fischer-Tropsch reaction conditions to form the Fischer-Tropsch product stream.

In some embodiments, the Fischer-Tropsch reaction conditions comprise a temperature in a range of 150° C. to 300° C., or a pressure in a range of 200 to 750 psig, or both.

In some embodiments, the Fischer-Tropsch catalyst comprises a Fe-, Co-, Ni-, Ru-based catalyst or combinations thereof.

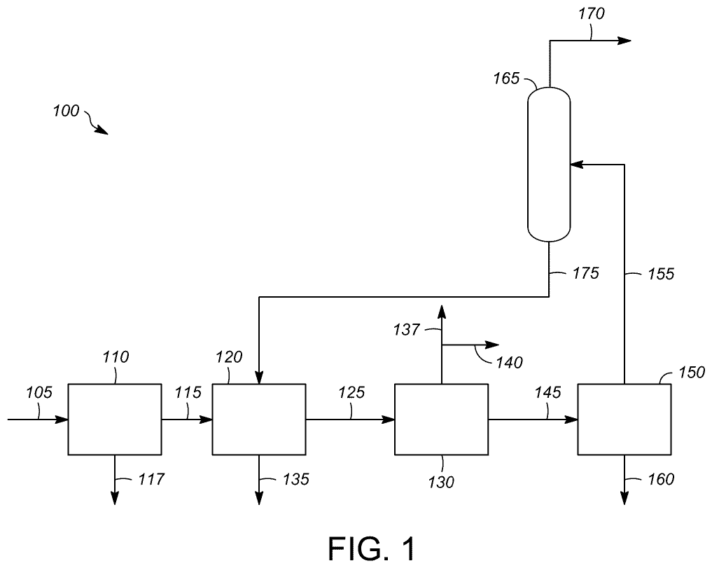

FIG. 1 illustrates a process 100 for converting Fischer-Tropsch naphtha/distillate into aromatic compounds. Fischer-Tropsch naphtha/distillate comprises C₆ to C₁₆ normal paraffins.

The synthesis gas stream 105 is sent to the Fischer-Tropsch reaction zone 110 wherein it is converted into C₅₊ normal paraffins. The Fischer-Tropsch reaction conditions comprise a temperature in a range of 150° C. to 300° C., or a pressure in a range of 200 to 750 psig, or both.

The Fischer-Tropsch catalyst comprises a Fe-, Co-, Ni-, Ru-based catalyst or combinations thereof.

The Fischer-Tropsch products are separated into a Fischer-Tropsch naphtha/distillate stream 115 comprising C₆ to C₁₆ normal paraffins and a second stream 117 comprising C₁₃₊ normal paraffins. The second stream 117 may go through a separate upgrade (e.g., hydroprocessing) to jet fuel or diesel fuel, for example.

The Fischer-Tropsch naphtha/distillate stream 115 is sent to a reforming reaction zone 120 comprising a reforming reactor where the C₆ to C₁₆ normal paraffins are converted to C₆ to C₁₆ aromatics. The reformer effluent stream 125 comprising C₆ to C₁₆ aromatics is sent to a fractionation section 130. A gas stream 135 comprising hydrogen may be recovered.

The reformer effluent stream 125 is separated in the fractionation section 130 comprising a fractionation column into an overhead gas stream 137 comprising C₁-C₂ paraffins, an overhead liquid stream 140 comprising C₃-C₅ paraffins, and an aromatic rich stream 145 comprising C₆₊ aromatics. The overhead gas stream 137 can be used as fuel. The C₃₋₄ paraffins in the overhead liquid stream 140 can be converted to C₃₋₄ olefins in a paraffin dehydrogenation reaction zone or used as LPG fuel, and the C₅ paraffins can be used as feed to a naphtha steam cracker.

The aromatic rich stream 145 is sent to a heavy aromatic splitter column 150 where it is separated into a light aromatic stream 155 comprising C₆₋₇ aromatics and a heavy aromatic stream 160 comprising C₈₊ aromatics. The heavy aromatic stream 160 can be blended with synthetic paraffinic kerosene to form sustainable aviation fuel.

The light aromatic stream 155 is sent a light aromatic splitter column 165 where it is separated into an overhead stream 170 comprising C₆ aromatics and unconverted paraffins and a bottom stream 175 comprising C₇ aromatics. The overhead stream 170 can be used for blending with high octane streams, including but not limited to, isomerate, alkylate, naphtha, or combinations thereof.

All or a portion of the bottom stream 175 can be recycled to the reforming reaction zone 120.

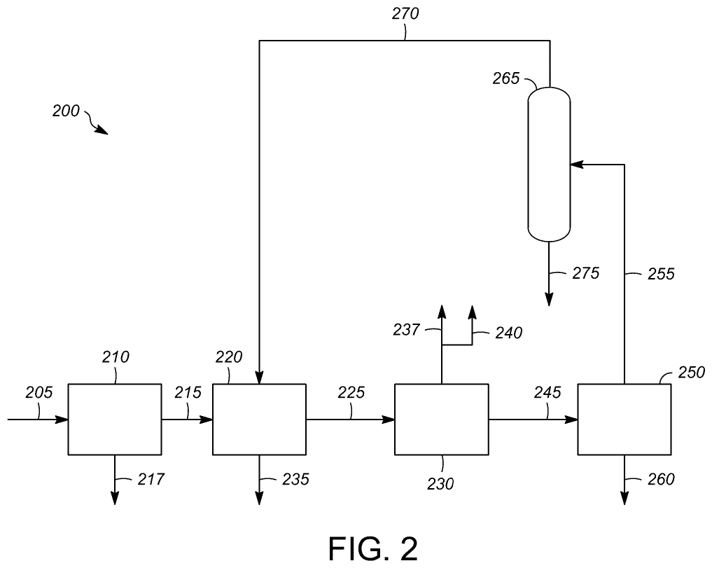

FIG. 2 illustrates a process 200 for converting Fischer-Tropsch naphtha/distillate into aromatic compounds. Fischer-Tropsch naphtha/distillate comprises C₆ to C₁₆ normal paraffins.

The synthesis gas stream 205 is sent to the Fischer-Tropsch reaction zone 210 wherein it is converted into C₅₊ normal paraffins. The Fischer-Tropsch products are separated into a Fischer-Tropsch naphtha/distillate stream 215 comprising C₆ to C₁₆ normal paraffins and a second stream 217 comprising C₁₃₊ normal paraffins.

The Fischer-Tropsch reaction conditions and catalysts are as discussed above.

The Fischer-Tropsch naphtha/distillate stream 215 is sent to a reforming reaction zone 220 comprising a reforming reactor where the C₆ to C₁₆ normal paraffins are converted to C₆ to C₁₆ aromatics. The reformed aromatic stream 225 comprising C₆ to C₁₆ aromatics is sent to a fractionation section 230. A gas stream 235 comprising hydrogen may be recovered.

The reformed aromatic stream 225 is separated in the fractionation section 230 comprising a fractionation column into an overhead gas stream 237 comprising C₁-C₂, an overhead liquid stream 240 comprising C₃-C₅, and an aromatic rich stream 245 comprising C₆₊ aromatics.

The aromatic rich stream 245 is sent to a heavy aromatic splitter column 250 where it is separated into a light aromatic stream 255 comprising C₆₋₇ aromatics and a heavy aromatic stream 260 comprising C₈₊ aromatics. The heavy aromatic stream 260 can be blended with synthetic paraffinic kerosene to form sustainable aviation fuel.

The light aromatic stream 255 is sent a light aromatic splitter column 265 where it is separated into an overhead stream 270 comprising C₆ aromatics and unconverted paraffins and a bottom stream 275 comprising C₇ aromatics.

The bottom stream 275 is a toluene rich stream. It can be treated to remove non-aromatics.

All or a portion of the overhead stream 270 can be recycled to the reforming reaction zone 220.

### EXAMPLES

### Example 1

From full Fischer-Tropsch liquid (FT stream comprising normal paraffins, isoparaffins, and olefin molecules up to 200 carbon atoms), a light F-T oil stream (FT product mixture having a normal boiling point in the range of 70° C. to about 290° C.) was separated out and recovered to have the composition listed in Table 1 below. The stream was processed in a reforming unit to generate aromatics. The product stream from reforming reactor was further processed in a separation system to remove hydrogen and other light gas (as a net-gas stream), and to recover three separate product streams: a light naphtha reformed stream (hydrocarbon mixture with normal boiling in the range of about 30° C. to about 90° C.), a C₇/C₈ reformed stream, and a heavy aromatic stream (aromatics mixture with an initial boiling point of about 140° C. or higher). The light naphtha reformed stream was recycled to the reforming unit. At optimal operation conditions, the compositions of product streams were listed in Table 1 below.

TABLE 1
light F-T oil stream reforming to Aromatics with light
naphtha product stream recycle. All composition in wt %

| | | light naphtha | | heavy |
|---|---|---|---|---|
| | light F-T oil | reformed | C₇/C₈ reformed | aromatic |
| | feed stream | stream | stream | stream |
| C4/C5s | — | 0.7 | | |
| C6s | 2.6 | 97.9 | 0.8 | |
| C7s | 9.1 | 1.4 | 66.9 | 5.0 |
| C8s | 20.0 | 0.1 | 32.3 | 23.3 |
| C9s | 26.9 | | | 29.2 |
| C10s | 25.5 | | | 25.1 |
| C11+ | 15.9 | | | 17.4 |
| Total n- | 76.9 | 1.7 | 7.4 | 0.5 |
| paraffin | | | | |
| Total iso- | 4.8 | 3.5 | 22.9 | 0.6 |
| paraffin | | | | |
| Total olefin | 16.2 | 0.7 | 3.7 | 0.1 |
| Total cyclo- | 2.0 | 0.1 | 2.4 | 0.6 |
| paraffin | | | | |
| Total | 0.01 | 94.1 | 63.5 | 98.2 |
| aromatics | | | | |

### Example 2

The same as Example 1, except that the C₇/C₈ reformed stream was recycled instead of the light naphtha reformed stream. The product stream compositions are listed in Table 2.

TABLE 2
light F-T oil stream reforming to Aromatics with toluene-rich
reformed product stream recycle. All composition in wt %

| | | light naphtha | | heavy |
|---|---|---|---|---|
| | light F-T oil | reformed | C₇/C₈ reformed | aromatic |
| | feed stream | stream | stream | stream |
| C4/C5s | — | 3.1 | | |
| C6s | 2.6 | 50.2 | 0.8 | |
| C7s | 9.1 | 45.2 | 92.8 | 5.0 |
| C8s | 20.0 | 1.5 | 6.3 | 26.2 |
| C9s | 26.9 | | | 28.3 |
| C10s | 25.5 | | | 24.0 |
| C11+ | 15.9 | | | 16.6 |
| Total n- | 76.9 | 16.7 | 3.1 | 0.2 |
| paraffin | | | | |
| Total iso- | 4.8 | 42.2 | 8.4 | 0.2 |
| paraffin | | | | |
| Total olefin | 16.2 | 3.2 | 0.8 | 0.0 |
| Total cyclo- | 2.0 | 0.5 | 0.5 | 0.1 |
| paraffin | | | | |
| Total | 0.01 | 37.4 | 87.2 | 99.4 |
| aromatics | | | | |

### Example 3

The same as Example 1, except that a heavy F-T oil stream was used as feed instead of the light F-T oil stream. The product stream compositions are listed in Table 3.

TABLE 3
heavy F-T oil stream reforming to Aromatics with light naphtha
reformed product stream recycle. All composition in wt %

| | | light naphtha | | heavy |
|---|---|---|---|---|
| | heavy F-T oil | reformed | C₇/C₈ reformed | aromatic |
| | feed stream | stream | stream | stream |
| C4/C5s | — | 0.7 | | |
| C6s | 0.4 | 95.6 | 0.7 | |
| C7s | 2.3 | 3.4 | 38.0 | 5.0 |
| C8s | 7.5 | 0.3 | 61.3 | 10.5 |
| C9s | 18.0 | | | 19.6 |
| C10s | 32.3 | | | 28.2 |
| C11+ | 39.6 | | | 36.7 |
| Total n- | 80.3 | 3.0 | 11.1 | 0.4 |
| paraffin | | | | |
| Total iso- | 1.9 | 6.9 | 47.9 | 0.5 |
| paraffin | | | | |
| Total olefin | 14.5 | 1.1 | 6.0 | 0.1 |
| Total cyclo- | 3.2 | 0.1 | 4.6 | 0.4 |
| paraffin | | | | |
| Total | 0.03 | 88.9 | 30.3 | 98.6 |
| aromatics | | | | |

### Example 4

The same as Example 2, except that a heavy F-T oil stream was used as feed instead of the light F-T oil stream. The product stream compositions are listed in Table 3.

TABLE 4
heavy F-T oil stream reforming to Aromatics with C₇/C₈
reformed product stream recycle. All composition in wt %

| | | light naphtha | | heavy |
|---|---|---|---|---|
| | heavy F-T oil | reformed | C₇/C₈ reformed | aromatic |
| | feed stream | stream | stream | stream |
| C4/C5s | — | 5.0 | | |
| C6s | 0.4 | 68.2 | 0.8 | |
| C7s | 2.3 | 26.3 | 89.5 | 5.0 |
| C8s | 7.5 | 0.4 | 9.7 | 12.7 |
| C9s | 18.0 | | | 19.7 |
| C10s | 32.3 | | | 27.3 |
| C11+ | 39.6 | | | 35.4 |
| Total n- | 80.3 | 21.2 | 7.9 | 0.3 |
| paraffin | | | | |
| Total iso- | 1.9 | 57.7 | 27.1 | 0.6 |
| paraffin | | | | |
| Total olefin | 14.5 | 3.9 | 2.0 | 0.1 |
| Total cyclo- | 3.2 | 0.5 | 1.2 | 0.1 |
| paraffin | | | | |
| Total | 0.03 | 16.7 | 61.7 | 98.9 |
| aromatics | | | | |

### Example 5

A full Fischer-Tropsch liquid was processed through a hydro-cracking and hydro-isomerization unit. The hydro-processed product was further processed in a separation system to remove hydrogen and other light gas, and to recover two separate product streams: a synthetic-paraffinic-kerosene stream and an unconverted oil stream. The unconverted oil stream was recycled to hydro-cracking while a portion of the SPK stream was processed in a continuous catalytic reforming (CCR) unit to produce aromatics. The SPK stream had the composition listed in Table 5 below. The reformed product was processed in the same way as described in Example 1. The product stream compositions are listed in Table 5.

TABLE 5
SPK stream reforming to Aromatics with light naphtha reformed
product stream recycle. All composition in wt %

| | | light naphtha | | heavy |
|---|---|---|---|---|
| | | reformed | C₇/C₈ reformed | aromatic |
| | SPK stream | stream | stream | stream |
| C4/C5s | — | 0.7 | | |
| C6s | 0.2 | 96.7 | 0.8 | |
| C7s | 4.4 | 2.5 | 61.4 | 5.0 |
| C8s | 13.0 | 0.1 | 37.9 | 16.0 |
| C9s | 23.2 | | | 24.3 |
| C10s | 28.8 | | | 25.5 |
| C11+ | 30.4 | | | 29.3 |
| Total n- | 47.9 | 2.8 | 8.7 | 0.4 |
| paraffin | | | | |
| Total iso- | 51.2 | 6.7 | 30.6 | 0.4 |
| paraffin | | | | |
| Total olefin | — | 0.9 | 3.7 | 0.1 |
| Total cyclo- | 0.8 | 0.1 | 2.8 | 0.3 |
| paraffin | | | | |
| Total | 0.04 | 89.4 | 54.2 | 98.8 |
| aromatics | | | | |

### Example 6

The same as Example 5, except that the C₇/C₈ reformed stream was recycled instead of the light naphtha reformed stream. The product stream compositions are listed in Table 6.

TABLE 6
SPK stream reforming to Aromatics with C7/C8 reformed
product stream recycle. All composition in wt %

| | | light naphtha | | heavy |
|---|---|---|---|---|
| | | reformed | C₇/C₈ reformed | aromatic |
| | SPK stream | stream | stream | stream |
| C4/C5s | — | 4.2 | | |
| C6s | 0.2 | 57.1 | 0.8 | |
| C7s | 4.4 | 37.4 | 88.5 | 5.0 |
| C8s | 13.0 | 1.3 | 10.7 | 17.8 |
| C9s | 23.2 | | | 24.1 |
| C10s | 28.8 | | | 24.8 |
| C11+ | 30.4 | | | 28.3 |
| Total n- | 47.9 | 18.2 | 4.8 | 0.3 |
| paraffin | | | | |
| Total iso- | 51.2 | 51.4 | 17.0 | 0.4 |
| paraffin | | | | |
| Total olefin | — | 3.4 | 1.3 | 0.0 |
| Total cyclo- | 0.8 | 0.5 | 0.7 | 0.1 |
| paraffin | | | | |
| Total | 0.04 | 26.6 | 76.2 | 99.2 |
| aromatics | | | | |

It can be seen from the above examples that the reforming reaction is effective in generating aromatics with the feed stream from appropriate cuts of Fischer-Tropsch product stream, hydrocracked Fischer-Tropsch product stream, or isomerized product stream. The aromatic-rich product streams also had appropriate molecular weight to serve as kerosene or gasoline blending components to satisfy the corresponding fuel specifications. The examples also demonstrated that a configuration change of the reforming reaction section could effectively shift the composition of the C₇/C₈ reformed stream to accommodate specific needs, such as fuel blending or renewable aromatic production. Such shifts are obviously not limited to the demonstrated composition shift on C₇/C₈ aromatics, and one skilled in the art could implement alternative configurations to adjust aromatic compositions of a different carbon range.

### Comparative Example 1

A traditional crude-oil based full range naphtha stream was obtained having the composition listed in Table C-1 below. The stream was processed in the same way as described in Example 2. The hydrogen production from this example is compared with that from Example 2 in Table 7. The results show that more hydrogen is produced by the reforming reaction in the case of Example 2.

TABLE C-1
Composition of fossil-fuel based full range naphtha stream

| | fossil-fuel |
|---|---|
| | based full range |
| | naphtha stream |
| C4/C5s | — |
| C6s | 7.6 |
| C7s | 26.4 |
| C8s | 27.6 |
| C9s | 22.1 |
| C10s | 13.6 |
| C11+ | 2.7 |
| Total n- | 13.35 |
| paraffin | |
| Total iso- | 28.01 |
| paraffin | |
| Total olefin | — |
| Total C5-ring | 18.6 |
| cyclo-paraffin | |
| Total C6-ring | 26.6 |
| cyclo-paraffin | |
| Total | 13.5 |
| aromatics | |

TABLE 7
H2 production comparison

| | | Comparative Example 1 |
|---|---|---|
| | Example 2 | Traditional Full-Range |
| | Light F-T Oil | Naphtha |
| H2 purity in Net-Gas from | 92 | 94 |
| Reforming Unit, mol % | | |
| Pure H2 generation | 0.464 kg/barrel | 0.369 kg/barrel |
| | of feed | of feed |

### Specific Embodiments

While the following is described in conjunction with specific embodiments, it will be understood that this description is intended to illustrate and not limit the scope of the preceding description and the appended claims.

A first embodiment of the invention is a method of converting Fischer-Tropsch naphtha/distillate to aromatics comprising providing a Fischer-Tropsch naphtha/distillate stream comprising C₆ to C₁₆ normal paraffins; reforming the Fischer-Tropsch naphtha/distillate stream in a reforming reaction zone comprising a reforming reactor in the presence of a reforming catalyst under reforming conditions to form a reformer effluent stream comprising C₁ to C₅, C₆₊ aromatic compounds, and hydrogen; separating the reformer effluent stream into an overhead gas stream comprising C₁-C₂ paraffins, an overhead liquid stream comprising C₃-C₅ paraffins, and an aromatic rich stream comprising the C₆₊ aromatics; separating the aromatic rich stream in a heavy aromatic splitter column into a light aromatic rich stream comprising C₆₋₇ aromatics and a heavy aromatic rich stream comprising C₈₊ aromatics; separating the light aromatic rich stream in a light aromatic splitter column into an overhead stream comprising C₆ aromatics and unconverted paraffins and a bottom stream comprising C₇ aromatics and unconverted paraffins; and recycling at least a first portion of the overhead stream from the light aromatic splitter column or at least a first portion of the bottom stream from the light aromatic splitter column to the reforming reaction zone. An embodiment of the invention is one, any or all of prior embodiments in this paragraph up through the first embodiment in this paragraph further comprising recovering a second portion of the overhead stream from the light aromatic splitter column; or recovering a second portion of the bottom stream from the light aromatic splitter column; or both. An embodiment of the invention is one, any or all of prior embodiments in this paragraph up through the first embodiment in this paragraph further comprising removing non-aromatics from the second portion of the overhead stream from the light aromatic splitter column, or the second portion of the bottom stream from the light aromatic splitter column, or both. An embodiment of the invention is one, any or all of prior embodiments in this paragraph up through the first embodiment in this paragraph further comprising blending the bottom stream from the heavy aromatic splitter column with a Fischer-Tropsch synthetic paraffinic kerosene stream to form a sustainable airplane fuel blend. An embodiment of the invention is one, any or all of prior embodiments in this paragraph up through the first embodiment in this paragraph further comprising blending the overhead stream from the light aromatic splitter column with a high octane stream to form a gasoline blend. An embodiment of the invention is one, any or all of prior embodiments in this paragraph up through the first embodiment in this paragraph further comprising recovering hydrogen gas from the reforming reaction zone. An embodiment of the invention is one, any or all of prior embodiments in this paragraph up through the first embodiment in this paragraph wherein the reforming reaction conditions comprise a temperature in a range of 400° C. to 600° C., or a pressure in a range of 60 psig to less than 400 psig, or both; or the reforming catalyst comprises a zeolite based catalyst with greater than 0 up to 1 wt % of a noble metal, or a chlorinated alumina based catalyst with greater than 0 up to 1 wt % of a noble metal, Sn, Ge, Ga, In, Re, or combinations thereof; or both. An embodiment of the invention is one, any or all of prior embodiments in this paragraph up through the first embodiment in this paragraph wherein providing the Fischer-Tropsch product stream comprises reacting synthesis gas comprising hydrogen, and carbon monoxide, or carbon dioxide, or both in a Fischer-Tropsch reaction zone comprising a Fischer-Tropsch reactor in the presence of a Fischer-Tropsch catalyst under Fischer-Tropsch reaction conditions to form the Fischer-Tropsch product stream. An embodiment of the invention is one, any or all of prior embodiments in this paragraph up through the first embodiment in this paragraph wherein the Fischer-Tropsch reaction conditions comprise a temperature in a range of 150° C. to 300° C., or a pressure in a range of 200 to 750 psig, or both; or the Fischer-Tropsch catalyst comprises a Fe-, Co-, Ni-, Ru-based catalyst or combinations thereof; or both.

A second embodiment of the invention is a method of converting Fischer-Tropsch naphtha/distillate to aromatics comprising providing a Fischer-Tropsch naphtha/distillate stream comprising C₆ to C₁₆ normal paraffins; reforming the Fischer-Tropsch naphtha/distillate stream in a reforming reaction zone comprising a reforming reactor in the presence of a reforming catalyst under reforming conditions to form a reformer effluent stream comprising C₁ to C₅, C₆₊ aromatic compounds, and hydrogen; separating the reformer effluent stream into an overhead gas stream comprising C₁-C₂ paraffins, an overhead liquid stream comprising C₃-C₅ paraffins, and an aromatic rich stream comprising the C₆₊ aromatics; separating the aromatic rich stream in a heavy aromatic splitter column into a light aromatic rich stream comprising C₆₋₇ aromatics and a heavy aromatic rich stream comprising C₈₊ aromatics; separating the light aromatic rich stream in a light aromatic splitter column into an overhead stream comprising C₆ aromatics and unconverted paraffins and a bottom stream comprising C₇ aromatics and unconverted paraffins; and recycling at least a first portion of the overhead stream from the light aromatic splitter column or at least a first portion of the bottom stream from the light aromatic splitter column to the reforming reaction zone; and recovering a second portion of the overhead stream from the light aromatic splitter column; and removing non-aromatics from the second portion of the overhead stream from the light aromatic splitter column; or recovering a second portion of the bottom stream from the light aromatic splitter column; and removing non-aromatics from the second portion of the bottom stream from the light aromatic splitter column; or both. An embodiment of the invention is one, any or all of prior embodiments in this paragraph up through the second embodiment in this paragraph further comprising blending the bottom stream from the heavy aromatic splitter column with a Fischer-Tropsch synthetic paraffinic kerosene stream to form a sustainable airplane fuel blend. An embodiment of the invention is one, any or all of prior embodiments in this paragraph up through the second embodiment in this paragraph further comprising blending the overhead stream from the light aromatic splitter column with a high octane stream to form a gasoline blend. An embodiment of the invention is one, any or all of prior embodiments in this paragraph up through the second embodiment in this paragraph further comprising recovering hydrogen gas from the reforming reaction zone. An embodiment of the invention is one, any or all of prior embodiments in this paragraph up through the second embodiment in this paragraph wherein the reforming reaction conditions comprise a temperature in a range of 400° C. to 600° C., or a pressure in a range of 60 psig to less than 400 psig, or both; or the reforming catalyst comprises a zeolite based catalyst with greater than 0 up to 1 wt % of a noble metal, or a chlorinated alumina based catalyst with greater than 0 up to 1 wt % of a noble metal, Sn, Ge, Ga, In, Re, or combinations thereof; or both. An embodiment of the invention is one, any or all of prior embodiments in this paragraph up through the second embodiment in this paragraph wherein providing the Fischer-Tropsch product stream comprises reacting synthesis gas comprising hydrogen, and carbon monoxide, or carbon dioxide, or both in a Fischer-Tropsch reaction zone comprising a Fischer-Tropsch reactor in the presence of a Fischer-Tropsch catalyst under Fischer-Tropsch reaction conditions to form the Fischer-Tropsch product stream. An embodiment of the invention is one, any or all of prior embodiments in this paragraph up through the second embodiment in this paragraph wherein the Fischer-Tropsch reaction conditions comprise a temperature in a range of 150° C. to 300° C., or a pressure in a range of 200 to 750 psig, or both; or the Fischer-Tropsch catalyst comprises a Fe-, Co-, Ni-, Ru-based catalyst or combinations thereof; or both.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A method of converting Fischer-Tropsch naphtha/distillate to aromatics comprising:
providing a Fischer-Tropsch naphtha/distillate stream comprising C₆ to C₁₆ normal paraffins;
reforming the Fischer-Tropsch naphtha/distillate stream in a reforming reaction zone comprising a reforming reactor in the presence of a reforming catalyst under reforming conditions to form a reformer effluent stream comprising C₁ to C₅, C₆₊ aromatic compounds, and hydrogen;
separating the reformer effluent stream into an overhead gas stream comprising C₁-C₂ paraffins, an overhead liquid stream comprising C₃-C₅ paraffins, and an aromatic rich stream comprising the C₆₊ aromatics;
separating the aromatic rich stream in a heavy aromatic splitter column into a light aromatic rich stream comprising C₆₋₇ aromatics and a heavy aromatic rich stream comprising C₈₊ aromatics;
separating the light aromatic rich stream in a light aromatic splitter column into an overhead stream comprising C₆ aromatics and unconverted paraffins and a bottom stream comprising C₇ aromatics and unconverted paraffins; and
recycling at least a first portion of the overhead stream from the light aromatic splitter column or at least a first portion of the bottom stream from the light aromatic splitter column to the reforming reaction zone.

2. The method of claim 1 further comprising:
recovering a second portion of the overhead stream from the light aromatic splitter column; or
recovering a second portion of the bottom stream from the light aromatic splitter column;
or both.

3. The method of claim 2 further comprising:
removing non-aromatics from the second portion of the overhead stream from the light aromatic splitter column, or the second portion of the bottom stream from the light aromatic splitter column, or both.

4. The method of claim 1 further comprising:
blending the bottom stream from the heavy aromatic splitter column with a Fischer-Tropsch synthetic paraffinic kerosene stream to form a sustainable airplane fuel blend.

5. The method of claim 1 further comprising:
blending the overhead stream from the light aromatic splitter column with a high octane stream to form a gasoline blend.

6. The method of claim 1 further comprising:
recovering the hydrogen from the reforming reaction zone.

7. The method of claim 6 further comprising:
recycling at least a portion of the hydrogen to the Fischer-Tropsch reaction zone.

8. The method of claim 1 wherein:
the reforming reaction conditions comprise a temperature in a range of 400° C. to 600° C., or a pressure in a range of 60 psig to less than 400 psig, or both; or
the reforming catalyst comprises a zeolite based catalyst with greater than up to 1 wt % of a noble metal, or a chlorinated alumina based catalyst with greater than 0 up to 1 wt % of a noble metal, Sn, Ge, Ga, In, Re, or combinations thereof;
or both.

9. The method of claim 1 wherein providing the Fischer-Tropsch product stream comprises:
reacting synthesis gas comprising hydrogen, and carbon monoxide, or carbon dioxide, or both in a Fischer-Tropsch reaction zone comprising a Fischer-Tropsch reactor in the presence of a Fischer-Tropsch catalyst under Fischer-Tropsch reaction conditions to form the Fischer-Tropsch product stream.

10. The method of claim 8 wherein:
the Fischer-Tropsch reaction conditions comprise a temperature in a range of 150° C. to 300° C., or a pressure in a range of 200 to 750 psig, or both; or
the Fischer-Tropsch catalyst comprises a Fe-, Co-, Ni-, Ru-based catalyst or combinations thereof;
or both.

11. A method of converting Fischer-Tropsch naphtha/distillate to aromatics comprising:
providing a Fischer-Tropsch naphtha/distillate stream comprising C₆ to C₁₆ normal paraffins;
reforming the Fischer-Tropsch naphtha/distillate stream in a reforming reaction zone comprising a reforming reactor in the presence of a reforming catalyst under reforming conditions to form a reformer effluent stream comprising C₁ to C₅, C₆₊ aromatic compounds, and hydrogen;
separating the reformer effluent stream into an overhead gas stream comprising C₁-C₂ paraffins, an overhead liquid stream comprising C₃-C₅ paraffins, and an aromatic rich stream comprising the C₆₊ aromatics;
separating the aromatic rich stream in a heavy aromatic splitter column into a light aromatic rich stream comprising C₆₋₇ aromatics and a heavy aromatic rich stream comprising C₈₊ aromatics;
separating the light aromatic rich stream in a light aromatic splitter column into an overhead stream comprising C₆ aromatics and unconverted paraffins and a bottom stream comprising C₇ aromatics and unconverted paraffins; and
recycling at least a first portion of the overhead stream from the light aromatic splitter column or at least a first portion of the bottom stream from the light aromatic splitter column to the reforming reaction zone; and
recovering a second portion of the overhead stream from the light aromatic splitter column; and
removing non-aromatics from the second portion of the overhead stream from the light aromatic splitter column;
or
recovering a second portion of the bottom stream from the light aromatic splitter column; and
removing non-aromatics from the second portion of the bottom stream from the light aromatic splitter column;
or both.

12. The method of claim 11 further comprising:
blending the bottom stream from the heavy aromatic splitter column with a Fischer-Tropsch synthetic paraffinic kerosene stream to form a sustainable airplane fuel blend.

13. The method of claim 11 further comprising:
blending the overhead stream from the light aromatic splitter column with a high octane stream to form a gasoline blend.

14. The method of claim 11 further comprising:
recovering the hydrogen from the reforming reaction zone.

15. The method of claim 14 further comprising:
recycling at least a portion of the hydrogen to the Fischer-Tropsch reaction zone.

16. The method of claim 11 wherein:
the reforming reaction conditions comprise a temperature in a range of 400° C. to 600° C., or a pressure in a range of 60 psig to less than 400 psig, or both; or
the reforming catalyst comprises a zeolite based catalyst with greater than 0 up to 1 wt % of a noble metal, or a chlorinated alumina based catalyst with greater than 0 up to 1 wt % of a noble metal, Sn, Ge, Ga, In, Re, or combinations thereof;
or both.

17. The method of claim 11 wherein providing the Fischer-Tropsch product stream comprises:
reacting synthesis gas comprising hydrogen, and carbon monoxide, or carbon dioxide, or both in a Fischer-Tropsch reaction zone comprising a Fischer-Tropsch reactor in the presence of a Fischer-Tropsch catalyst under Fischer-Tropsch reaction conditions to form the Fischer-Tropsch product stream.

18. The method of claim 17 wherein:
the Fischer-Tropsch reaction conditions comprise a temperature in a range of 150° C. to 300° C., or a pressure in a range of 200 to 750 psig, or both; or
the Fischer-Tropsch catalyst comprises a Fe-, Co-, Ni-, Ru-based catalyst or combinations thereof;
or both.
